(19) United States
(12) Patent Application Publication
(10) Pub. No.: US 2008/0216529 A1
(43) Pub. Date: Sep. 11, 2008

(54) CONVERTIBLE DOOR LOCK DEVICE

(75) Inventors: Hoduk KIM, Dalseo-gu (KR); Soohyun KIM, Dalseo-gu (KR); Gwisoo LEE, Buk-gu (KR); Duckwon KANG, Dalseo-gu (KR)

Correspondence Address: CANTOR COLBURN, LLP, 20 Church Street, 22nd Floor, Hartford, CT, 06103, US

(73) Assignee: HYUNDAE METAL CO., LTD., Daegu (KR)

(21) Appl. No.: 12/043,577

(22) Filed: Mar. 6, 2008

(30) Foreign Application Priority Data
Mar. 6, 2007 (KR) 10-2007-0022147

(51) Int. Cl. E05B 63/00

(52) U.S. Cl. 70/266

(57) ABSTRACT

The present invention relates to a convertible door lock device with a removable supporting pipe, which guarantees compatibility in construction according to a type of a door, being capable of selectively employing a movement preventing structure implemented by a supporting pipe according to the door type. The door lock device according to the embodiment of the present invention comprises the supporting pipe constituted by a pipe body including a fastening hole therein and a head part formed at one end of the pipe body, and a seating recess formed on an inner surface of the outer bracket for selective insertion of the head part of the supporting pipe. The head part of the supporting pipe is inserted in the seating recess of the outer bracket and the pipe body is inserted in a supporting hole dedicatedly formed on the door at a position outer than the mounting hole to be bolt-connected at the inside of the door through the fastening hole.

### BACKGROUND OF THE INVENTION

1. Field of the Invention

The present invention relates to a movement-preventing convertible door lock device, and more particularly to a movement-preventing door lock device guaranteeing compatibility in construction thereof according to the environmental conditions such as a type of a door, by structuring a supporting pipe, which prevents movement of the door lock device in lateral directions during a switching operation of inner and outer levers for opening the door, to be removably mounted.

2. Description of the Related Art

As generally known, a door lock device comprises a cylinder body mounted to a mounting hole formed at a door, an inner lever mounted to the inside of the door to supply a force for operating the cylinder body, and an outer lever mounted to the outside of the door to supply an operating force for the cylinder body.

Here, the cylinder body is equipped with a latch bolt which controls opening and closing of the door in association with a striker mounted to a door frame, by receiving the operating force from the inner or outer lever. The cylinder body is fixed to the door, being compressed by a pressing plate and a bracket respectively formed at the inside and the outside of the door.

Although the cylinder body is compressively fixed by the pressing plate and the bracket, however, the cylinder body may move in lateral directions when the inner lever or the outer lever is rotated to open the door.

To solve this problem, it has been suggested to form a fitting protrusion having a pointed front end on one surface of the pressing plate, facing one surface of the door, in order to reinforce the cohesion between the pressing plate and the door.

Sometimes, the lateral movement caused by the operation of the inner or outer lever can be prevented merely by press-fit of the door through the fitting protrusion of the pressing plate. However, although the press-fit is achieved by the fitting protrusion of the pressing plate, the door lock device may be moved, in lateral directions if a user turns the inner lever and the outer lever excessively.

Accordingly, there has been a need for a reinforcing structure for fixing the door lock device to the door more stably.

### SUMMARY OF THE INVENTION

Therefore, the present invention has been made in view of the above problems, and it is an object of the present invention to provide a convertible door lock device with a removable supporting pipe, which guarantees compatibility in construction according to a type of a door, being capable of selectively employing a movement preventing structure implemented by a supporting pipe according to the door type.

In accordance with the present invention, the above and other objects can be accomplished by the provision of a door lock device with a removable supporting pipe, comprising a cylinder body mounted to a mounting hole of a door to control opening and closing of the door lock device by being engaged with and released from a striker mounted to a door frame as a latch bolt advances and retreats by receiving a switching force from an outer lever and an inner lever directly connected to an end of the cylinder body, an inner bracket and an outer bracket mounted to both sides of the door to compressively fix the cylinder body to the door through a connection structure, the door lock device further comprising a movement preventing structure which includes the supporting pipe constituted by a pipe body including a fastening hole therein and a head part formed at one end of the pipe body, and a seating recess formed on an inner surface of the outer bracket for selective insertion of the head part of the supporting pipe, and is structured by inserting the head part of the supporting pipe in the seating recess of the outer bracket and inserting the pipe body in a supporting hole dedicatedly formed on the door at a position outer than the mounting hole, such that the door lock device has compatibility in construction according to a type of a door, by selectively employing the movement preventing structure implemented by the supporting pipe according to the door type.

With the above structure, the door lock device according to the embodiment of the present invention is capable of guaranteeing compatibility in construction so that an operator can vary the construction type depending on environmental conditions, while preventing movement of the door lock device in lateral directions that may be generated during a switching operation of the levers for opening the door.

More particularly, in the door lock device according to the embodiment of the presenting invention, the supporting pipe penetrating the supporting hole of the door is mounted to the outer bracket such that the door is penetrated at two or more positions including a position formed with the mounting hole and a position penetrated by the supporting pipe, thereby restricting the lateral movement during the switching operation of the inner and outer levers. Especially, since the supporting pipe has a convertible structure being selectively mounted to the outer bracket, the operator is able to decide whether to use the supporting pipe considering the environmental conditions. Thus, the compatibility is

guaranteed.

Therefore, there is no need to separately manufacture an outer bracket with the supporting pipe and another outer bracket without the supporting pipe. As a result, the manufacturing cost can be reduced, and the operator can selectively use the outer bracket during the construction without having to carry all types of the outer brackets.

Preferably, the head part of the supporting pipe may have a sectional shape of a polygonal, oval, or composite form of them or is implemented by a rotation preventing protrusion, and the seating recess of the outer bracket for insertion of the head part may have a corresponding shape to the head part.

Additionally, the outer bracket may include a pressing plate at an inside thereof, including a shoulder hole having a greater diameter than the pipe body of the supporting pipe but a smaller diameter than the head part, such that the supporting pipe inserted in the seating recess can be prevented from separating by mounting to the shoulder hole the head part of the supporting pipe inserted in the seating recess of the outer bracket.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows an assembled state of a convertible door lock device having a removable supporting pipe, according to an embodiment of the present invention;

FIG. 2 shows a state where an outer bracket, the supporting pipe and a pressing plate are connected with one another in the convertible door lock device of FIG. 1; and

FIG. 3 shows a mounted state of the convertible door lock device of FIG. 1 and more particularly, FIG. 3a shows the convertible door lock device being mounted to the door unequipped with a supporting hole without using the supporting pipe and FIG. 3B shows the convertible door lock device being mounted to the door equipped with the supporting hole by using the supporting pipe.

### DETAILED DESCRIPTION OF THE PREFERRED EMBODIMENTS

Hereinafter, a convertible door lock device with a removable supporting pipe according to an exemplary embodiment of the present invention will be described in detail with reference to the accompanying drawings.

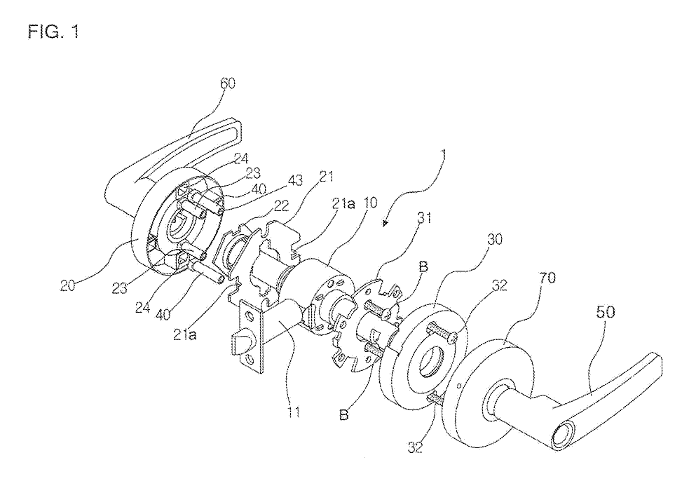

Referring to FIG. 1 through FIG. 3, the door lock device 1 according to the embodiment of the present invention comprises a cylinder body 10 penetratingly mounted to a mounting hole 110 of a door 100.

An outer lever 60 and an inner lever 50 are engaged with both ends of the cylinder body 10, respectively. A latch bolt 11 engaged with a striker (not shown) mounted to a door frame is mounted on one side of the cylinder body 10. Therefore, as a user switches the outer lever 60 or the inner lever 50, the latch bolt 11 comes in and out, thereby enabling opening and closing of the door 100.

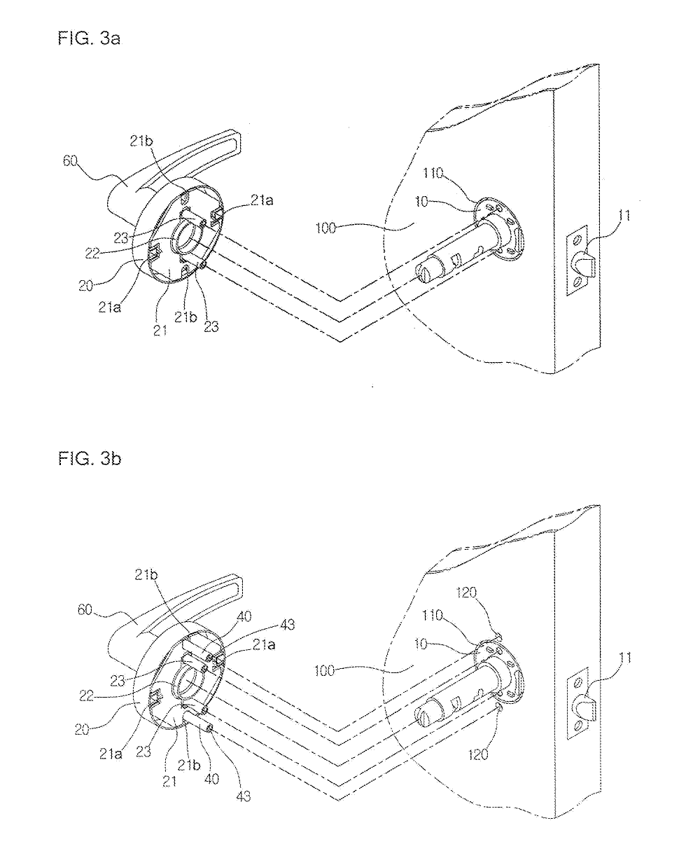

Here, the outer lever 60 is engaged with the cylinder body 10 by penetrating an outer bracket 20 through a bush 22. The cylinder body 10 is compressively fixed to the door 100 through engagement between a pair of fixing pipes 23 formed on the outer bracket 20 and a pair of fixing bolts B entering from the outside of the door 10 at the other side of the cylinder body 10. As shown in FIG. 3a, the fixing pipes 23 penetrate the cylinder body 10. An undescribed reference numeral 70 refers to a cover that covers an inner bracket 30.

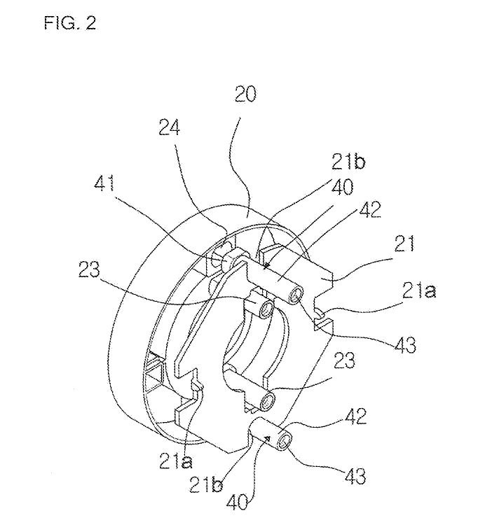

In addition, pressing plates 21 and 31 are mounted at insides of the outer bracket 20 and the inner bracket 30 both facing the door 100, respectively, to press the door 100 through surface contact. As shown in FIG. 2, a fitting protrusion 21a connected into the door 100 by force-fit is formed on an outer circumference of the pressing plate 21 mounted within the outer bracket 20. The fitting protrusion 21a prevents movement of the door lock device 1 by being inserted in a recess (not shown) formed on the mounting hole 110 or forcedly fit into the door 100 during mounting of the door lock device.

In some cases, the movement of the door lock device 1 in lateral directions, caused by the switching operation of the inner lever 50 or the outer lever 60, may be prevented merely by the force-fit of the fitting protrusion 21a of the pressing plate 21 with the door 100. However, in case that the user turns the inner lever 50 or the outer lever 60 excessively, the door lock device 1 is still possible to move in lateral directions. Therefore, sometimes, an advanced structure for more stably fixing the door lock device 1 is required.

In consideration of such a problem, a pair of supporting pipes 40 are further mounted to the outer bracket 20 to penetrate supporting holes 120 dedicatedly formed on the door 100 at positions outer than the mounting hole 110. Thus, since the door lock device 1 penetrates the door 100 by at least, two positions, the undesired lateral movement of the door lock device 1 can be prevented during the switching operation of the inner lever 50 or the outer lever 60.

As described above, the supporting pipe 40 is an auxiliary member employed to enhance fixing of the door lock device 1 to the door 100 and therefore selectively used depending on the construction system or environmental conditions. In other words, the use of the supporting pipe 40 is optional.

It is so inefficient to dedicatedly manufacture and supply different door lock devices for the above reason. Therefore, according to this embodiment, the supporting pipe 40 is separately formed rather than being integrally formed with the outer bracket 20, more specifically, the supporting pipe 40 comprising a pipe body 42 including a fastening hole 43 with a screw thread formed therein, and a head, part 41 formed at one end of the pipe body 42. Whereas, at a position outer than the fixing pipe 23 on an inner surface of the outer bracket 20, a seating recess 24 is formed for the head part 41 of the supporting pipe 40 to be inserted in and separated from, thereby enabling connection and separation of the supporting pipe 40 with respect to the outer bracket 20.

The seating recess 24 of the outer bracket 20 and the head part 41 of the supporting pipe 40 may have an oval or polygonal sectional shape to correspond to each other. Alternatively, the seating recess 24 and the head part 41 may be implemented by a fixing protrusion and a fixing recess that can be engaged corresponding to each other and thereby restricting the movement of each other.

Referring to FIG. 2, the head part 41 and the seating recess 24 each have the sectional shape of a substantial square form with two facing sides curved.

In a state of being inserted in the door 100 by penetrating the supporting hole 120 of the door 100, the supporting pipe 40 is stably fixed as the supporting bolt 32 entering through the inner bracket 30 is fastened to the fastening hole 43 having the screw thread. Since the seating recess 24 and the head part 41 of the supporting pipe 40 have the oval or polygonal sectional shape, the supporting pipe 40 can be securely connected with the seating recess 24, accordingly preventing idle rotation during the screw connection.

Additionally, as shown in FIG. 2, the pressing plate 21 formed inside the outer bracket 20 includes a shoulder hole 21b having a greater diameter than the pipe body 42 of the supporting pipe 40 but a smaller diameter than the head part. 41. Therefore, when the head part 41 of the supporting pipe 40 as inserted in the seating recess 24 of the outer bracket 20 is mounted to the shoulder hole 21b, separation of the supporting pipe 40 can be prevented.

By thus structuring the supporting pipe 40 to be separately mounted to the outer bracket 20 rather than being integrally formed with the outer bracket 20, the operator can decide whether to employ the supporting pipe 40 according to the environmental conditions.

More specifically, if the door 100 is not equipped with the supporting hole 12 0 as shown in FIG. 3a or when the improved fixing by the supporting pipe 40 is not necessary, the operator can mount the door lock device 1 to the door 100 through the mounting hole 110 without inserting the supporting pipe 40 in the outer bracket 20. On the other hand, if the door 100 includes the supporting hole 120 as shown in FIG. 3b or when the supporting pipe 40 is required for the improve fixing, the operator can mount the door lock device 1 to the door 100 by inserting the supporting pipe 40 in the outer bracket 20.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A convertible door lock device with a removable supporting pipe, comprising a cylinder body mounted to a mounting hole of a door to control opening and closing of the door lock device by being engaged with and released from a striker mounted to a door frame as a latch bolt advances and retreats by receiving a switching force from, an outer lever or an inner lever directly connected to an end of the cylinder body, an inner bracket and an outer bracket mounted to both sides of the door to compressively fix the cylinder body to the door through a connection structure,
the door lock device further comprising a movement preventing structure which includes the supporting pipe constituted by a pipe body including a fastening hole therein and a head part formed at one end of the pipe body; and a seating recess formed on an inner surface of the outer bracket for selective insertion of the head part of the supporting pipe, and is structured by inserting the head part of the supporting pipe in the seating recess of the outer bracket and inserting the pipe body in a supporting hole dedicatedly formed on the door at a position outer than the mounting hole, such that the door lock device has compatibility in construction according to a type of a door, by selectively employing the movement preventing structure implemented by the supporting pips according to the door type.

2. The door lock device according to claim 1, wherein the head part of the supporting pipe has a sectional shape of a polygonal, oval, or composite form of them or is implemented by a rotation preventing protrusion, and the seating recess of the outer bracket for insertion of the head part has a corresponding shape to the head part.

3. The door lock device according to claim 1, wherein the outer bracket includes a pressing plate at an inside thereof, including a shoulder hole having a greater diameter than the pipe body of the supporting pipe but a smaller diameter than the head part, such that the supporting pipe inserted in the seating recess can be prevented from separating by mounting to the shoulder hole the head part of the supporting pipe inserted in the seating recess of the outer bracket.
